(19) United States
(12) Patent Application Publication
(10) Pub. No.: US 2012/0215663 A1
(43) Pub. Date: Aug. 23, 2012

(54) SYSTEM AND METHOD FOR PROVIDING A MANAGED GRAPHIC DESIGN COMMUNITY

(75) Inventors: Matthew D. Coene, Ontario, NY (US); Shannon Leigh Reddy, Rochester, NY (US)

(73) Assignee: Xerox Corporation, Norwalk, CT (US)

(21) Appl. No.: 13/029,470

(22) Filed: Feb. 17, 2011

(51) Int. Cl. G06Q 30/00

(52) U.S. Cl. 705/27.1

(57) ABSTRACT

A system and method for providing a managed graphic design community. The graphic design community including one or more graphic designers can be created in order to design and upload a template within a social network environment. A community management application can be configured in association with a managed service provider in order to receive, analyze and display the template with respect to a customer. An appropriate compensation/payment can be provided with respect to the graphic designer based on a reward provided by the customer in the social network. Such an approach employs an enforcement process to prevent the designers from uploading similar/existing templates in the graphic design community and to protect the templates.

### TECHNICAL FIELD

Embodiments are generally related to online publishing and subscription data processing systems and methods. Embodiments are also related to graphic design communities. Embodiments are additionally related to the provision of a managed graphic design community.

### BACKGROUND OF THE INVENTION

A digital online value added service provider can allow retail customers to order a variety of customized products, for example, calendars, greeting cards, notepads, photo books, and so forth, via a website. A template with respect to such products can be designed by professional graphic designers for various events, such as, birthdays, anniversaries, Christmas, Hanukkah, Valentine's Day, and so on. By utilizing such a website, a retail customer can insert text and/or photos into a template via the website. In association with the service provider, the customers will personalize the template and electronically send a finished product to, for example, friends and relatives. Customers utilizing such a service provider website are more concerned about sending similar designs selected by other users in, for example, a social network environment, and may require diversity and attractiveness with respect to the template.

Conventionally, the service providers may offer a contract with respect to the graphic designer in the community in order to concept and create a bulk group of templates, though individual template concepts would be considered as well. The graphic designers will create diverse and attractive concepts (e.g., 3-5 templates), based on the contract, and upload the design or designs to a service provider's server in order to receive compensation/payment with respect to the design. Additionally, templates need to be completed annually in order to have fresh designs which bear significant ongoing costs. Such approaches, however, are costly, insecure and place an added burden with respect to the online service provider. Furthermore, the service providers are unable to effectively post multiple designs online and unable to obtain customer feedback before posting the design online.

Based on the foregoing, it is believed that a need exists for an improved system and method for providing a managed graphic design community with respect to an online service provider, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved online value added service provider system and method.

It is another aspect of the disclosed embodiments to provide for an improved managed graphic design community.

It is a further aspect of the disclosed embodiments to provide for an improved system and method for providing for a managed graphic design community with respect to an online service provider.

The aforementioned aspects and other objectives and advantages can now be achieved as described herein. A system and method for providing a managed graphic design community, is disclosed herein. The graphic design community generally includes one or more graphic designers. Such a community can be configured for designing and uploading a template within a social network. A community management application (e.g., an evaluation algorithm) can be associated with a managed service provider (e.g., an e-commerce system) in order to receive, analyze and display the template with respect to a customer. An appropriate compensation/payment can be provided to the graphic designer based on a reward (e.g., initial user rating and ongoing popularity) provided by the customer in the social network or in the total number of downloads. Such an approach employs an automated enforcement process to prevent the designers from uploading similar/existing templates in the graphic design community and to protect the templates.

A card selection application can be configured in association with a customer device in order to present the customer with a standard network request for accessing the templates. The customer can be further routed to an interface upon obtaining the permission in order to select the templates from a series of categories. Synchronously, the customer profile can be extracted from a social network database in order to populate a user database associated with the managed service provider. The designer can publish a raster image of the template in the network to obtain an approval from the service provider. The managed service provider along with the management algorithm drops out the colors in the template and stores a digital image fingerprint of the template utilizing a GVC (Grid View Configuration) technology.

The graphic design template can be scanned and evaluated in order to provide an instant feedback report with respect to the uniqueness of the template within the community. The compensation/payment can be further provided to the graphic designers based on the feedback report utilizing the community management application. The rewards, trends and ranks with respect to template can be displayed at a dashboard of the service provider. The compensation/payment with respect to the graphic designer can be provided periodically based on the percentage of profit, popularity and creativity of the template as judged by the customers and the total number of template downloads. Such a system and method provides secure and cost-effective management solution within a wide range of digital online value added service application.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including a graphic design community management module, operating system, and a user interface, in accordance with the disclosed embodiments;

FIG. 3 illustrates a graphical representation of a graphic design community management system, in accordance with the disclosed embodiments;

FIG. 4 illustrates a block diagram of the graphic design community management system, in accordance with the disclosed embodiments;

FIGS. 5-7 illustrate GUI representing templates with respect to the graphic design community management system, in accordance with the disclosed embodiments; and

FIG. 8 illustrates a high level flow chart of operation illustrating logical operation steps of a method for providing managed graphic design community within a social network, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

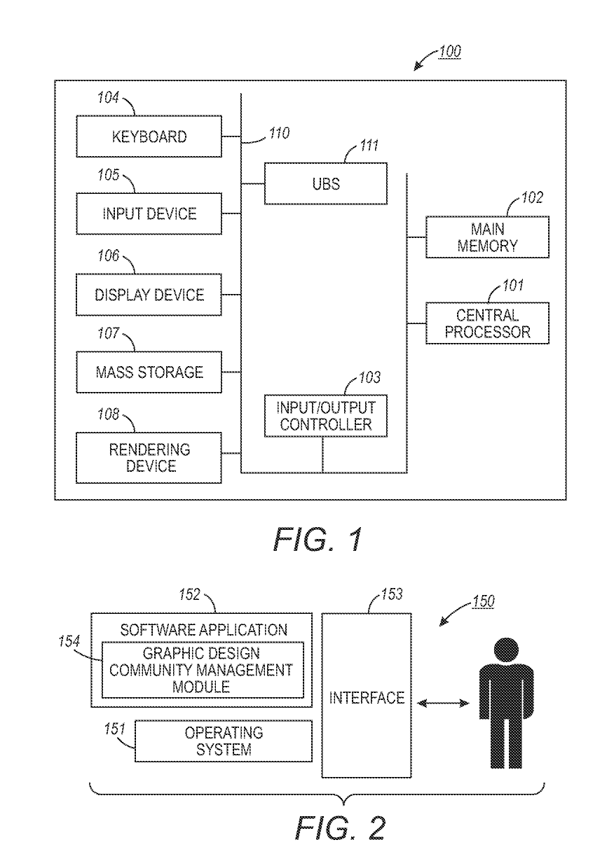

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device, such as a mouse, track ball, pen device, etc), a display device 106, a mass storage 107 (e.g., a hard disk), and a USB (Universal Serial Bus) peripheral connection 111. Additional input/output devices, such as a rendering device 108 (e.g., printer, scanner, fax machine, etc), for example, may be associated with the data-processing system 100 as desired. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

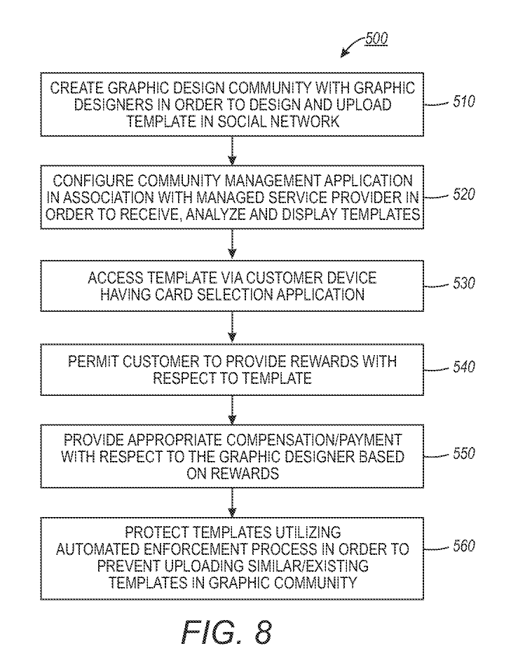

The interface 153, which is preferably a graphical user interface (GUI), can serve to display results, whereupon a user may supply additional inputs or terminate a particular session. In some embodiments, operating system 151 and interface 153 can be implemented in the context of a “Windows” system. It can be appreciated, of course, that other types of systems are potential. For example, rather than a traditional “Windows” system, other operation systems, such as, Linux may also be employed with respect to operating system 151 and interface 153. The software application 154 can include, for example, a graphic design community management module 152 for managing the designs and respective compensations with respect to the graphic designers. The community management module 152 can include instructions, such as those of method 500 discussed herein with respect to FIG. 8.

FIGS. 1-2 are thus intended as an example, and not as an architectural limitation with respect to particular embodiments. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms, including Macintosh, UNIX, LINUX, and the like.

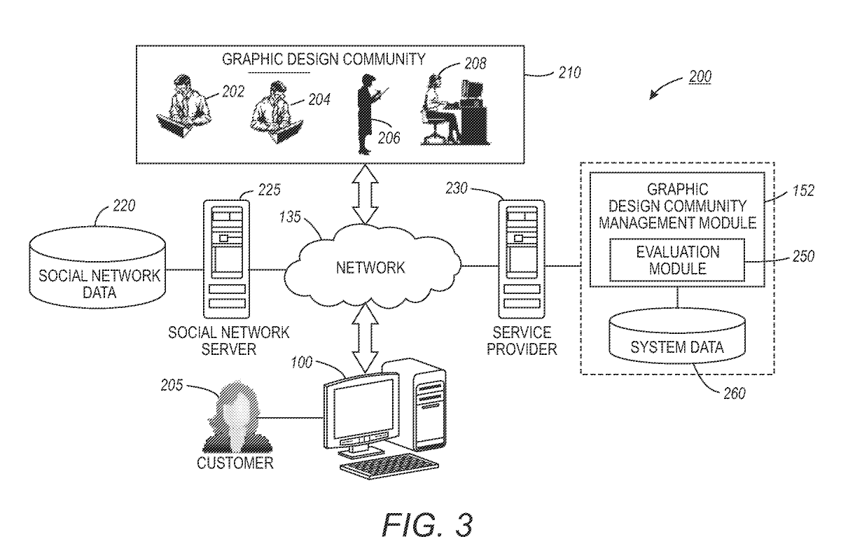

FIG. 3 illustrates a graphical representation of the graphic design community management system 200, in accordance with the disclosed embodiments. Note that in FIGS. 1-8, identical or similar blocks are generally indicated by identical reference numerals. The management system 200 can be employed to provide a secure and cost-effective management solution within a wide range of digital online value added services businesses. The management system 200 generally includes a graphic design community 210, one or more customer devices such as a customer device 100, a service provider server 230 having a design community management module 152 that are operatively configured in association with a network 135.

The graphic design community 210 includes one or more graphic designers 202, 204, 206, and 208 in order to create and upload a template 340 within the social network 135. Note that the graphic designers 202-208 can be such as, for example, architects, graphic artists, designers, programmers, quality assurance engineers, or others with domain experience applicable to the templates. The designers 202-208 of the community 210 can be employees of, consultants, members of an organization, enterprise, and a community fostering collaborative production. The designers 202-208 can submit the user information such as, tax information, payment preferences and other identity information in order to register with the service provider server 230.

The service provider server 230 includes an evaluation algorithm 250 for analyzing, receiving and evaluating the templates 340 with respect to the designers 202-208 in the community 210. Note that the service provider server 230 can be an e-commerce system, depending upon the design considerations. The social network server 225 (e.g., a Facebook server) includes a database 220 for storing the social network user data 220. Such data 220 can be accessed by the service provider server 230 and the customers 205 pertaining to the template 340, and can be stored into a user database 260 of the service provider server 230.

The template 340 disclosed herein can be such as, for example, but not limited to an aesthetic design. An aesthetic design is a representation of a decorative, artistic and/or technical work that is created by the graphic designer 202-208 within the community 210. The template 340 can be a design, such as a logo, a graphic, or an illustration. The design can be a purposeful or inventive arrangement of parts or details. The template 340 can also be the layout and graphics for a webpage, website, graphical user interface, and the like. The template 340 can be a basic scheme or pattern that affects and controls function or development or a prototype of a webpage or pages, a software program or an application. In one embodiment, the template 340 can be a logo that an individual, company, or other organization intends to use on its website, business cards, signage, stationary, and/or marketing collateral and the like. In another embodiment, the design is a webpage template, including colors, graphics, and text layout that will appear on various pages within a particular web site.

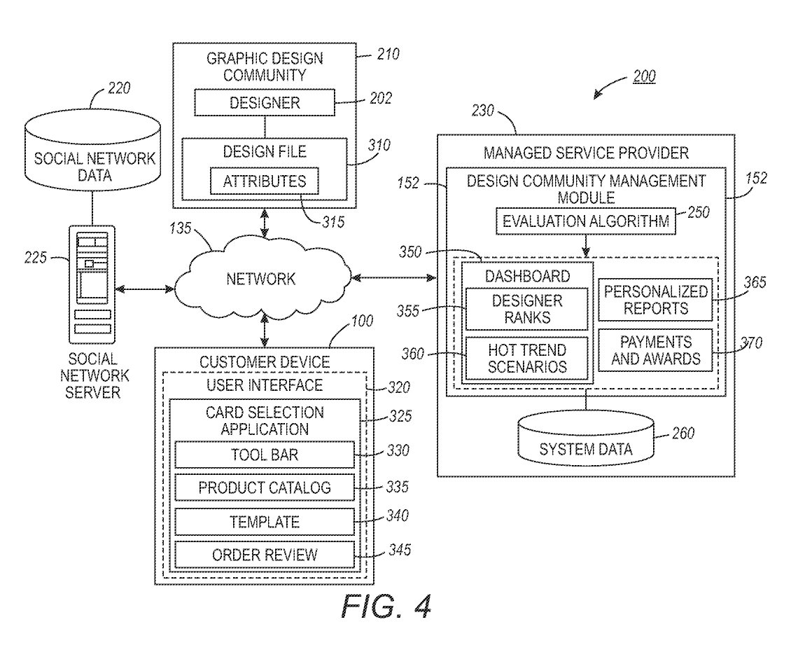

FIG. 4 illustrates a block diagram of the graphic design community management system 200, in accordance with the disclosed embodiments. The community management system 200 adapts an automated enforcement process in order to prevent uploading similar/existing templates 340 in the graphic design community 210. A card selection application 325 is configured in association with a customer device 100 in order to present the customer 205 with a standard network request for accessing the templates 340. The customer 340 can be routed to an interface upon obtaining the permission in order to select the templates 340 from a series of categories. The customer profile can be extracted from the social network database 220 in order to populate the user database 260 of the managed service provider 230.

The card selection application 325 displays a toolbar 330, a product catalog 335, the template 340 and an order review 345 with respect to the template 340. The managed service provider server 230 includes a dash board 350 for providing hot trend scenarios 360 and ranks 355 with respect to the template 340. The compensation/payment with respect to the graphic designer 202 can be periodically provided based on the percentage of profit, popularity and creativity of the design as judged by the customers 205. The service provider server 230 also provides a personalized report 365 and payment/reward 370 with respect to the designers in the social network 135.

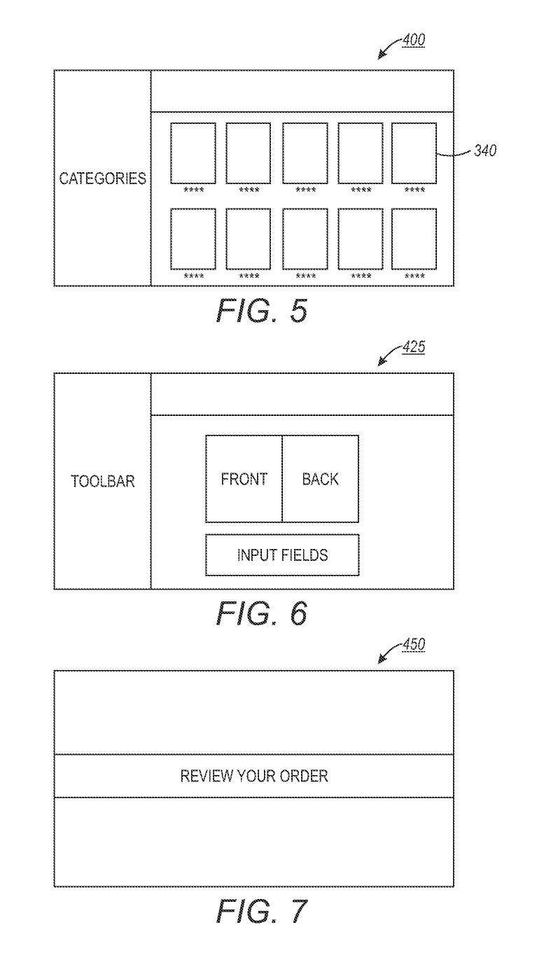

FIG. 5 illustrates a GUI 400 representing a list of templates 340, in accordance with the disclosed embodiments. Note that the GUI 400-450 can be implemented utilizing a GUI such as, for example, the GUI 153 depicted in FIG. 2 herein, and may be provided by a module, such as, for example, module 152 (i.e., a software application). Note that in computing, a GUI window is generally a visual area containing some type of user interface. Such a “window” usually (but not always) possesses a rectangular shape, and displays the output of and may allow input to one or more processes. Such windows are primarily associated with graphical displays, where it can be manipulated with an input device, for example, the keypad 104 depicted in FIG. 1. A GUI using “windows” as one of its main “metaphors” is often referred to as a windowing system.

FIG. 6 illustrates a GUI 425 representing the toolbar 330 with respect to the template 340, in accordance with the disclosed embodiments. The customer 205 can typically edit the front, back and input fields of the template 340 in order to send similar personalized templates 340 to other users in the social network environment. The customers 205 can be permitted to select the templates 340 based on the recipients hobbies and interests, but are not limited to doing so. FIG. 7 illustrates a GUI 450 representing an order review option with respect to the customer 205 in the social network 135, in accordance with the disclosed embodiments. The customer 205 can provide a feedback report with respect to the template 340 within the social network 135. The rewards can be further provided to the graphic designers 202 based on the feedback report utilizing the community management application 152. Note that the customer data can be asynchronously provided to the designers 202-208 in order to provide a continuous improvement in the community 210.

The designer 202-208 can publish a raster image of the template 340 in the network 135 in order to obtain approval from the service provider 230. The managed service provider 230, along with the evaluation algorithm 250, drops out the colors in the design template 340 and stores a digital image fingerprint of the template 340 utilizing a grid view configuration (GVC) technology. The managed service provider 230 also provides an appropriate compensation/payment with respect to the graphic designer 202-208 based on a reward (e.g., initial user rating and ongoing popularity) provided by the customers 205 in the network 135. Note that the compensations with respect to the designer 202-208 are provided on weekly, monthly, or yearly basis based on designer preferences. The graphic design community 210 includes a freelancer application 310 for submitting a template file 310 including one or more attributes 315 in the social network 135.

FIG. 8 illustrates a high level flow chart of operation illustrating logical operation steps of a method 500 for managing the graphic design community 210 within the social network 135, in accordance with the disclosed embodiments. Note that the method 500 can be implemented in the context of a computer-useable medium that contains a program product, including, for example, a module or group of modules. The graphic design community 210 including one or more graphic designers 202-208 can be created in order to design and upload the template 340 within the social network environment, as illustrated at block 510. The evaluation algorithm 250 can be configured in association with managed service provider 230 in order to receive, analyze and display the template with respect to the customer 205, as depicted at block 520.

The template 340 can be accessed by the customer 205 utilizing the customer device 100 having the card selection application 325, as illustrated at block 530. The customer 205 can be permitted to provide the rewards such as, initial user rating and ongoing popularity, with respect to the selected template 340, as depicted at block 540. An appropriate compensation/payment can be provided with respect to the graphic designer 202-208 based on a reward provided by the customer 205 in the social network 135, as illustrated at block 550. The templates 340 can be protected utilizing an automated enforcement process in order to prevent uploading similar/existing templates in the graphic design community 210, as depicted at block 560.

The graphic design management system typically reduces the ongoing administrative costs for contract management within the community by maintaining the design costs at a level rate as a percent of profit. The graphic design community described herein effectively covers the market needs for various categories of templates in a wide range of social networking applications. The graphic designers can therefore feel loyalty and pride as they win awards for good work and compensation for popularity. The system and method disclosed herein therefore provides a wide range of automated administration functions within the graphic design community.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method, comprising:
creating a graphic design community that includes a plurality of graphic designers in order to design and upload a template within a social network;
configuring a community management application in association with a managed service provider in order to receive, analyze and display said template with respect to a customer; and
providing an appropriate compensation with respect to said plurality of graphic designers based on a reward provided by said customer in said social network and an automated enforcement process that prevents said plurality of graphic designers from uploading similar templates in said graphic design community while protecting said template.

2. The method of claim 1 further comprising configuring a card selection application in association with a customer device in order to present said customer with a standard network request for accessing said template.

3. The method of claim 1 further comprising routing said customer to a user interface upon obtaining a permission in order to select said template from a series of categories.

4. The method of claim 1 further comprising pulling a customer profile from a social network database in order to start populating a user database associated with said managed service provider.

5. The method of claim 1 further comprising:
publishing a raster image of said template in said social network in order to obtain approval from said managed service provider;
dropping at least one color in said template; and
storing an image fingerprint of said template utilizing a grid view configuration technology in order to scan and evaluate said template.

6. The method of claim 1 further comprising providing an instant feedback report with respect to uniqueness of said template within said graphic design community.

7. The method of claim 1 further comprising providing said compensation with respect to said plurality of graphic designers based on said feedback report utilizing said community management application.

8. The method of claim 1 further comprising displaying a hot trend scenario and a rank with respect to said template at a dashboard of said service provider.

9. The method of claim 1 further comprising configuring said at least one reward to comprise at least one of the following types of rewards: an initial user rating; and ongoing popularity.

10. The method of claim 1 wherein said community management application comprises an evaluation algorithm.

11. A system, comprising:
a processor;
a data bus coupled to said processor; and
a computer-usable medium embodying computer code, said computer-usable medium being coupled to said data bus, said computer program code comprising instructions executable by said processor and configured for:
creating a graphic design community that includes a plurality of graphic designers in order to design and upload a template within a social network;
configuring a community management application in association with a managed service provider in order to receive, analyze and display said template with respect to a customer; and
providing an appropriate compensation with respect to said plurality of graphic designers based on a reward provided by said customer in said social network and an automated enforcement process that prevents said plurality of graphic designers from uploading similar templates in said graphic design community while protecting said template.

12. The system of claim 11 wherein said instructions are further configured for providing a card selection application in association with a customer device in order to present said customer with a standard network request for accessing said template.

13. The system of claim 11 wherein said instructions are further configured for routing said customer to a user interface upon obtaining a permission in order to select said template from a series of categories.

14. The system of claim 11 wherein said instructions are further configured for pulling a customer profile from a social network database in order to start populating a user database associated with said managed service provider.

15. The system of claim 11 wherein said instructions are further configured for:
publishing a raster image of said template in said social network in order to obtain approval from said managed service provider;
dropping at least one color in said template; and
storing an image fingerprint of said template utilizing a grid view configuration technology in order to scan and evaluate said template.

16. The system of claim 11 wherein said instructions are further configured for providing an instant feedback report with respect to uniqueness of said template within said graphic design community.

17. The system of claim 11 wherein said instructions are further configured for providing said compensation with respect to said plurality of graphic designers based on said feedback report utilizing said community management application.

18. The system of claim 11 wherein said instructions are further configured for displaying a hot trend scenario and a rank with respect to said template at a dashboard of said service provider.

19. The system of claim 11 wherein said community management application comprises an evaluation algorithm.

20. A system, comprising:
a processor;
a data bus coupled to said processor; and
a computer-usable medium embodying computer code, said computer-usable medium being coupled to said data bus, said computer program code comprising instructions executable by said processor and configured for:
creating a graphic design community that includes a plurality of graphic designers in order to design and upload a template within a social network;
configuring a community management application in association with a managed service provider in order to receive, analyze and display said template with respect to a customer;
providing an appropriate compensation with respect to said plurality of graphic designers based on a reward provided by said customer in said social network and an automated enforcement process that prevents said plurality of graphic designers from uploading similar templates in said graphic design community while protecting said template; and
providing a card selection application in association with a customer device in order to present said customer with a standard network request for accessing said template.
